(19) United States
(12) Patent Application Publication
(10) Pub. No.: US 2008/0315459 A1
(43) Pub. Date: Dec. 25, 2008

(54) ARTICLES AND METHODS FOR REPLICATION OF MICROSTRUCTURES AND NANOFEATURES

(75) Inventors: Jun-Ying Zhang, Woodbury, MN (US); Mark J. Pellerite, Woodbury, MN (US); Suresh Iyer, Woodbury, MN (US); Thomas P. Klun, Lakeland, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/766,477

(22) Filed: Jun. 21, 2007

(51) Int. Cl. B28B 7/36

(52) U.S. Cl. 264/338; 252/60; 425/436 R

(57) ABSTRACT

An article is provided that includes a mold comprising a pattern, a metal-containing layer in contact with the pattern, and a release agent that includes a functionalized perfluoropolyether bonded to the metal-containing layer. Also provided is a method of replication that includes the mold.

### FIELD

This application relates to articles and methods for the replication of microstructures and nanofeatures. The articles include a mold with a patterned surface, a metal-containing layer, and a release coating bonded to the surface.

### BACKGROUND

There is an interest in commercial and industrial applications to reduce the size of articles and devices. This is particularly true in the area of electronics where devices have been made smaller and smaller. Nanostructured devices, for example, can be used in articles such as flat panel displays, chemical sensors, and bioabsorption substrates. Microstructured articles have found commercial utility in, for example, electroluminescent devices, field emission cathodes for display devices, microfluidic films, and patterned electronic components and circuits.

Various mold-based nanoreplication technologies have been reported, such as nanoembossing lithography, nanoimprint lithography, ultraviolet-nanoimprint lithography, and step-and-flash imprint lithography. In the nanoreplication process, replica quality can be negatively affected by interfacial phenomena such as wettability and adhesion between the mold and the replicated polymeric patterns. Such effects are particularly important for nanoscale features, due to the high surface to volume ratio of those features. The quality of the features of replicas formed from nanoreplication relies on the treatment of the mold with a release, or anti-adhesion layer. The release layer typically reduces the surface energy of the mold surface by forming a thin, thermally-stable surface that can be used to cast replication polymers and accurately reproduce microstructures and nanofeatures. In nanoreplication applications, where the pattern sizes of the mold are very small—on the order of micrometers to nanometers—conventional coating technology cannot be applied because a thick release layer on the mold can change the feature dimensions of the pattern. There are many applications for which it would be desirable to make hierarchical articles where smaller structures (nanofeatures, for example) are present upon larger structures (microstructures, for example). These applications include sensors, optical devices, fluidic devices, medical devices, molecular diagnostics, plastic electronics, micro-electromechanical systems (MEMS) and nano-electromechanical systems (NEMS). It would be advantageous to be able to mass produce microstructures, nanofeatures or hierarchical structures that contain nanofeatures and microstructures in a rapid, cost-effective, high quality manner.

### SUMMARY

There is a need for a method of replicating articles using molds that can reproduce features on the nanometer and/or micrometer scale without significant distortion of the features and in a rapid and cost-effective manner. One approach to satisfying this need is to use a release agent that is very thin, thermally stable, and can form a chemical bond to the surface of the mold. The chemical bond can be a strong bond such as a covalent bond, ionic bond, dative bond (coordinate covalent bond), polar covalent bond, or banana bond. Self-assembled monolayers (SAMs) are one of the types of materials that can be used as anti-adhesion or release layers in the replication of microstructures and nanofeatures. SAMs are physicochemically stable and can modify the surface properties of the mold without affecting the shape of the nanofeatured patterns on the mold since the monomolecular SAM film is only on the order of 1-2 nm in thickness (much smaller than the mold features). SAMs are particularly useful when they can be chemically bonded to the mold surface.

In one aspect, what is disclosed is an article comprising a mold comprising a patterned surface, a metal-containing layer having an outer surface, wherein the metal-containing layer is supported on the patterned surface, and a release agent comprising a functionalized perfluoropolyether bonded to the outer surface of the metal-containing layer.

In another aspect, what is disclosed is a method of replication comprising providing a mold comprising a patterned surface and a metal-containing layer having an outer surface, wherein the metal-containing layer is supported on the patterned surface, and applying a release agent comprising a functionalized perfluoropolyether to the outer surface of the metal-containing layer. Some functionalized perfluoropolyethers, such as, for example, perfluoropolyether phosphonates or perfluoropolyether benzotriazoles, can be thermally stable, form SAMs when coated on a mold, and can chemically bond to the mold surface.

In yet another aspect, what is disclosed is a method of replication comprising providing a mold comprising a patterned surface and a metal-containing layer having an outer surface, wherein the metal-containing layer is supported on the patterned surface, applying a release agent comprising a functionalized perfluoropolyether to the outer surface of the metal-containing layer, adding a first replication polymer to the mold such that the first replication polymer is in contact with the release agent, and separating the first replication polymer from the mold.

As used herein, the articles “a”, “an”, and “the” are used interchangeably with “at least one” to mean one or more of the elements being described.

As used herein, the term “etch mask” refers to a structure that is held in proximity to or in contact with the substrate so as to allow or to prevent exposure of regions of the substrate to optical or etchant beams.

As used herein, the term “etch resist” refers to a layer or layers of material that is placed on the substrate and can be patterned to form a resist pattern, which, under the etching conditions used, etches more slowly than the substrate.

As used herein, the term “hierarchical” refers to constructions that have two or more elements of structure wherein at least one element has nanofeatures and at least another element has microstructures. The elements of structure can consist of one, two, three, or more levels of depth.

As used herein, the terms “microstructure” or “microstructures” refer to structures that range from about 0.1 microns to about 1000 microns in their longest dimension. In this application, the ranges of nanofeatures and microstructures overlap.

As used herein, the terms “nanofeature” or “nanofeatures” refer to features that range from about 1 nm to about 1000 nm in their longest dimension. The nanofeatures of any article of this application are smaller than the microstructure generated on the article.

As used herein, the term “alkali metal” refers to a sodium ion, potassium ion, or lithium ion.

As used herein, the term “alkane” refers to saturated hydrocarbons that are linear, branched, cyclic, or combinations thereof. The alkane typically has 1 to 30 carbon atoms. In some embodiments, the alkane has 1 to 20, 1 to 10, 1 to 8, 1 to 6, 1 to 4, or 1 to 3 carbon atoms.

As used herein, the term “alkoxy” refers to a group of formula —OR where R is an alkyl group.

As used herein, the term “alkyl” refers to a monovalent moiety formed by abstraction of a hydrogen atom from an alkane. The alkyl can have a linear structure, branched structure, cyclic structure, or combinations thereof. A cycloalkyl is a cyclic alkyl and is a subset of an alkyl group.

As used herein, the term “alkylene” refers to a divalent moiety formed by abstraction of two hydrogen atoms from an alkane. The alkylene can have a linear structure, branched structure, cyclic structure, or combinations thereof.

As used herein, the term “aryl” refers to a monovalent moiety of a carbocyclic aromatic compound having one to five connected rings, multiple fused rings, or combinations thereof. In some embodiments, the aryl group has four rings, three rings, two rings, or one ring. For example, the aryl group can be phenyl.

As used herein, the term “arylene” refers to a divalent moiety of a carbocyclic aromatic compound having one to five connected rings, multiple fused rings, or combinations thereof. In some embodiments, the arylene group has four rings, three rings, two rings, or one ring. For example, the arylene group can be phenylene.

As used herein, the term “carbonyl” refers to a divalent group of formula —(CO)— where the carbon is attached to the oxygen with a double bond.

As used herein, the term “carbonyloxy” refers to a divalent group of formula —(CO)O—.

As used herein, the term “carbonylimino” refers to a divalent group of formula —(CO)NR^{d}— where R^{d} is hydrogen or alkyl.

As used herein, the term “fluoropolyether” refers to a compound or group having three or more saturated or unsaturated hydrocarbon groups linked with oxygen atoms (i.e., there are at least two catenated oxygen atoms). At least one, and typically two or more, of the hydrocarbon groups has at least one hydrogen atom replaced with a fluorine atom. The hydrocarbon groups can have a linear structure, branched structure, cyclic structure, or combinations thereof.

As used herein, the term “halo” refers to chlorine, bromine, iodine, or fluorine.

As used herein, the term “heteroalkyl” refers to a monovalent moiety formed by abstraction of a hydrogen atom from a heteroalkane.

As used herein, the term “heteroalkylene” refers to a divalent moiety formed by abstraction of two hydrogen atoms from a heteroalkane.

As used herein, the term “perfluoroalkane” refers to an alkane in which all of the hydrogen atoms are replaced with fluorine atoms.

As used herein, the term “perfluoroalkanediyl” refers to a divalent moiety formed by abstraction of two fluorine atoms from a perfluoroalkane where the radical centers are located on different carbon atoms.

As used herein, the term “perfluoroalkanetriyl” refers to a trivalent moiety formed by abstraction of three fluorine atoms from a perfluoroalkane.

As used herein, the term “perfluoroalkyl” refers to an alkyl group in which all of the hydrogen atoms are replaced with fluorine atoms.

As used herein, the term “perfluoroalkoxy” refers to an alkoxy group in which all of the hydrogen atoms are replaced with fluorine atoms.

As used herein, the term “perfluoroether” refers to a fluoroether in which all of the hydrogens on all of the hydrocarbon groups are replaced with fluorine atoms.

As used herein, the term “perfluoropolyether” refers to a fluoropolyether in which all of the hydrogens on all of the hydrocarbon groups are replaced with fluorine atoms.

As used herein, the term “phosphonic acid” refers to a group, or compound that includes a group, of formula —(P═O)(OH)₂ attached directly to a carbon atom.

As used herein, the term “phosphonate” refers to a group, or compound that includes a group, of formula —(P═O)(OX)₂ attached directly to a carbon atom where X is selected from an alkali, alkyl group, or a five to seven membered heterocyclic group having a positively charged nitrogen atom. Phosphonates can be esters or salts of the corresponding phosphonic acid.

As used herein, the term “phosphate” refers to a salt or ester of formula —O(P═O)(OX)₂ attached directly to a carbon atom where X is selected from hydrogen, alkali metal, alkyl, cycloalkyl, ammonium, ammonium substituted with an alkyl or cycloalkyl, or a five to seven membered heterocyclic group having a positively charged nitrogen atom.

As used herein, the term “sulfonamido” refers to a group of formula —SO₂NR^{a}— where R^{a} is an alkyl or aryl.

The above summary of the present invention is not intended to describe each disclosed embodiment of every implementation of the present invention. The detailed description which follows more particularly exemplifies illustrative embodiments.

### DETAILED DESCRIPTION

This disclosure provides an article comprising a mold comprising a patterned surface, a metal-containing layer having an outer surface, wherein the metal-containing layer is supported on the patterned surface, and a release agent comprising a functionalized perfluoropolyether bonded to the outer surface of the metal-containing layer. The mold can be used to produce replicas of the pattern. The release agent can be bonded to the metal-containing layer in contact with the pattern in the mold and can be very thin-even as thin as a monomolecular layer. The bonding of the release agent to the pattern can allow for multiple replicas of the pattern to be made from the same mold with one application of release layer. Additionally if the release layer is very thin, as in a monolayer, the replicas can have very fine structure which facilitates the replication of nanofeatures or microstructures.

The articles of this disclosure comprise a mold comprising a patterned surface. The patterned surface can be a configuration or configurations that can include regular arrays or random arrays of features or structures or a combination of both. The patterned surface can include nanofeatures that range from about 1 nm to about 1000 nm in their longest dimension and microstructures that can range from about 0.1 μm to about 1000 μm in their longest dimension. The patterns on the surface can include hierarchical patterns that comprise, for example, smaller features such as nanofeatures upon larger structures, for example, microstructures.

Hierarchical patterns can be made by adding nanofeatures to an existing microstructure. This has been accomplished, for example, by growing nanocrystals onto microstructured articles, nanoimprinting microstructured articles, and by using interferometric lithographic techniques to make submicron or nanoscale gratings and grids on microsubstrates for optical applications. Additionally, applicants' cofiled and copending patent application, entitled “Method of Making Hierarchical Articles” (Zhang et al.) (Attorney Docket No. 62973US002), filed on Jun. 21, 2007, discloses a method of making an article comprising providing a substrate that has microstructures, adding nanoparticles to the microstructures, and etching at least a portion of the microstructures to produce a hierarchical article, wherein the nanoparticles etch at a substantially slower rate than silicon dioxide, and wherein etching comprises using nanoparticles as an etch resist. This patent application is hereby incorporated by reference in its entirety. The applicants additionally have disclosed a method of making a hierarchical article that includes providing a substrate that has a nanofeatured pattern, adding a layer to the substrate, and generating a microstructured pattern in the layer, wherein generating a microstructured pattern comprises removing at least a portion of the layer to reveal at least a portion of the substrate. This disclosure can be found in applicants' cofiled and copending patent application, entitled “Method of Making Hierarchical Articles” (Zhang et al.) (Attorney Docket No. 62972US002), filed on Jun. 21, 2007, which is hereby incorporated by reference in its entirety.

The mold can comprise a substrate. The substrate can be selected from a variety of materials. These materials include polymeric films such as, for example, polyimide or polymethylmethacrylate, or inorganic materials such as glasses, silicon wafers, and silicon wafers with coatings. The coatings on the silicon wafers can include polymer film coatings such as, for example, polyimides or urethane acrylates, or can include inorganic coatings such as, for example, an SiO₂ coating. Additionally the substrate can be a porous glass as disclosed by Wiltzius et al., Phys. Rev. A., 36(6), 2991, (1987) entitled “Structure of Porous Vycor Glass”; a polymer surface dewetted by a thin polymer film as described by Higgens et al., Nature, 404, 476 (2000) entitled “Anisotropic Spinodal Dewetting As a Route to Self-assembly of Patterned Surfaces”, a mixed ionic crystal such as described in Ringe et al, Solid State Ionics, 177, 2473 (2006) entitled “Nanoscaled Surface Structures of Ionic Crystals by Spinodal Composition”, or a light sensitive substrate. Light sensitive substrates can include photosensitive polymers, ceramics, or glasses.

The substrate can have a nanofeatured pattern that includes nanofeatures. The pattern can be in the form of a regular array of nanofeatures, a random arrangement of nanofeatures, a combination of different regular or random arrangements of nanofeatures, or any arrangement of nanofeatures. The nanofeatured pattern can be formed directly in the substrate or in an added layer. Additionally, the nanofeatured pattern can be formed as a part of the substrate.

The nanofeatured pattern can be formed directly in the substrate. The pattern can be generated using patterning techniques such as anodization, photoreplication, laser ablation, electron beam lithography, nanoimprint lithography, optical contact lithography, projection lithography, optical interference lithography, and inclined lithography. The pattern can then be transferred into the substrate by removing existing substrate material using subtractive techniques such as wet or dry etching, if necessary. The nanofeatured pattern can be transferred into the substrate by wet or dry etching through a resist pattern. Resist patterns can be made from a variety of resist materials including positive and negative photoresists using methods known by those skilled in the art. Wet etching can include, for example, the use of an acid bath to etch an acid sensitive layer or the use of a developer to remove exposed or unexposed photoresist. Dry etching can include, for example, reactive ion etching, or ablation using a high energy beam such as, for example, a high energy laser or ion beam.

Alternatively, a layer or layers of nanoparticles coated on the top of the substrate can act as a resist pattern by preventing exposure of the substrate to radiation or etching where the nanoparticles reside, but allowing exposure of the resist in the areas not in direct line of the nanoparticles. The nanoparticles can be dispersed and can, optionally, be combined with a binder to make them immobile on the article of the added layer. Nanoparticles that can be useful as an etch mask include oxides such indium-tin oxide, aluminum oxide, silicon dioxide, titanium dioxide, zirconium dioxide, tantalum oxide, hafnium oxide, niobium oxide, magnesium oxide, zinc oxide, indium oxide, tin oxides, and other metal or metalloid oxides. Other useful nanoparticles include nitrides such as silicon nitride, aluminum nitride, gallium nitride, titanium nitride, carbon nitride, boron nitride and other nitrides known by those skilled in the art to be nanoparticles. It is also possible to use metal nanoparticles as an etch mask. Metal nanoparticles include nanoparticles of aluminum, copper, nickel, titanium, gold, silver, chromium, and other metals. Indium-tin oxide (ITO) nanoparticles have been found to be dispersible in isopropanol and adherent to polyimide films and can be used as an etch mask without modification or the addition of other additives. Other nanoparticles can be dispersible with the addition of article modification groups as known by those skilled in the art.

It is also contemplated that the nanofeatured pattern can be formed on the substrate by coating the substrate with metal such as, for example, gold, silver, aluminum, chromium, nickel, titanium, and copper, annealing the metal to form islands of metal and then using the islands of metal as an etch mask for the substrate itself. Etching of the substrate can be accomplished with any of the etching techniques mentioned earlier in this application. It is also within the scope of this disclosure to form the nanofeatured pattern using chromonics as disclosed, for example, in U.S. Ser. No. 11/626,456 (Mahoney et al.), which is incorporated herein by reference, as an etch mask.

The nanofeatured pattern can also be formed by direct modification of the substrate without the addition of any additional material. For example laser ablation can remove selected areas of the substrate to form nanofeatures. If the substrate is light-sensitive then it can be possible to form the nanofeatured pattern by exposing the photosensitive substrate by optical projection or contact lithography and then developing. Alternatively, interference photolithography can be used to generate a nanopattern in a photosensitive material. Anodization of a conductive substrate can also be used to form the nanofeatured pattern.

Patterns can be formed directly in the substrate by using a high energy beam to ablate the substrate. The pattern can be defined by rastering the beam, or by using an etch mask or resist to protect parts of the substrate. This approach can be particularly useful for forming nanofeatured patterns subtractively in some polymer substrates such as, for example, polyimide.

The nanofeatured pattern can also be formed by adding a material to the substrate. The material can include the nanofeatured pattern when it is added to the substrate, or the material can be added to the substrate and then subsequently have the nanofeatured pattern generated in it. The nanofeatured pattern can be formed in the material before it is added to the substrate. The nanofeatured pattern can be formed in the material subtractively using the methods herein. The nanofeatured pattern can also be cast into the added material. For example, a replica with a negative relief image of the nanofeatured pattern can be used to form the nanofeatured pattern in the material. In this case, the material can be a thermoplastic material that flows at a high temperature and then becomes solid at room temperature or at use temperature. Alternatively, the material can be a thermoset and can be cured using a catalyst, heat, or photoexposure depending upon its chemistry. When the material is added to the substrate it can be added as a solid. The material can be added to the substrate by lamination or by adding a thin adhesive material. Materials that can be used for this purpose include thermoplastic polymers that flow at elevated temperatures but not at lower temperatures such as room temperature. Examples of thermoplastic polymers that can be used include acrylics; polyolefins; ethylene copolymers such as poly(ethylene/acrylic acid); fluoropolymers such as polytetrafluoroethylene and polyvinylidene fluoride; polyvinylchloride; ionomers; ketones such as polyetheretherketone; polyamides; polycarbonates; polyesters; styrene block copolymers such as styrene-isoprene-styrene; styrene butadiene-styrene; styrene acrylonitrile; and others known to those skilled in the art. Other useful materials for forming a substrate with nanofeatures include thermosetting resins such as, for example, polydimethylsiloxanes, urethane acrylates and epoxies. An example of thermosetting resins can be a photocrosslinkable system, such as a photocurable urethane acrylate, that forms a polymeric substrate with nanofeatures upon curing.

When addition of a material to the substrate is used to produce the nanofeatured pattern, a number of materials can be used. For example, a photoresist (negative or positive) can be added to the substrate. The photoresist can be exposed to light passing through a photomask or projected through a lens system to produce nanofeatures. Additionally interference lithography can be used to produce the nanofeatured pattern. Interference lithography is discussed, for example, in S. R. J. Brueck, “Optical and Interferometric Lithography-Nanotechnology Enablers”, Proceedings of the IEEE, Vol. 93 (10), October 2005. It is also contemplated that the photoresist can be exposed by directly writing with a rastered or digitally-pulsed laser beam. The exposed (positive photoresist) or unexposed (negative photoresist) areas can then be removed by using a developing solution to dissolve the undesired photoresist. The resist can then be hardened by physical or chemical means for use in later steps. The developed photoresist can then be hardened and used as described herein. Useful photoresists include negative photoresists such as UVN 30 (available from Rohm and Haas Electronic Materials, Marlborough, Mass.), and FUTURREX negative photoresists (available from Futurrex, Franklin, N.J.), and positive photoresists such as UV5 (available from Rohm and Haas Electronic Materials) and Shipley 1813 photoresist (Rohm and Haas Electronic Materials). Other photopolymers can be used to generate the nanofeatures. Any photopolymer system known to those skilled in the art can be used to form nanofeatures upon exposure to radiation (UV, IR, or visible).

The resist pattern produced by exposure and development of the photoresist materials, can also be transferred into the substrate by direct removal of unwanted materials by dry etching using the photoresist as resist pattern. For example, reactive ion etching can be used to remove parts of the substrate or materials added to the substrate in a manner so as to generate nanofeatures. In reactive ion etching, a reactive gas species, such as CF₄ or SF₆ is added to a reaction chamber. A plasma is generated by applied radio frequency (RF) potentials. This causes some of the gas molecules to be ionized. These ionized particles can be accelerated towards various electrode articles and can etch or dislodge molecules from the article they impinge upon. Typically, reactive ion etching is accomplished through an etch mask or directly using a rastered or digitally controlled beam.

Alternatively, a thin metal layer can be deposited on the substrate, the photoresist can be deposited on the metal, and the photoresist can be patterned, then the resist pattern can be transferred into the metal by wet etching. In this way a metal pattern can be generated that can serve as a resist pattern for dry etching of the substrate. Consequently a large etch rate difference between the (metal) resist pattern and the substrate can be achieved.

As another example, an electron beam (e-beam) can be used to create a resist pattern in an e-beam resist. For example, poly(methyl methacrylate), available from MicroChem, Corp., Newton, Mass., can be added to the substrate and an etch mask that includes nanofeatures can be produced by development of the resist. Subsequently the substrate can be reactive ion etched through the resist pattern.

The article of this invention can include a metal-containing layer having an outer surface, wherein the metal-containing layer is supported on the patterned surface of the article. The metal-containing layer can include either a metal or a metal oxide or both. The metal-containing layer can be the mold itself, or the mold can be metallized with, for example, a thin layer of metal that has been vapor deposited or deposited by electroless plating or both. Useful metals for metallization include nickel, copper, chromium, aluminum, silver and titanium. There can be other layers, including other metal layers between the patterned surface of the article and the metal-containing layer having an outer surface. For example, if the patterned surface of made of a nonconducting material, a thin conductive layer, such as, for example, a silver layer can be deposited on the patterned surface to make it conductive. This can be done, for example, by electroless plating methods known to those skilled in the art. Subsequently, a thicker metal layer, such as nickel, can then be deposited electrolytically on the thin conductive layer. Other layers can be present between the patterned surface and the metal-containing layer having an outer surface.

The metal-containing layer having an outer surface is supported on the patterned surface of the article. It can be chemically bonded to, adhered to, or placed upon the patterned surface. It can be in direct contact with the patterned surface or can be in contact with another layer that is in contact with the patterned surface. The metal-containing layer has an outer surface. The outer surface is available for bonding to the release agent. The outer surface also has a patterned surface. The metal-containing layer can be thin enough so that the outer surface of the layer has the patterned surface from the mold—that is the patterned surface of the mold projects though the metal-containing layer and is present on the outer surface of the metal-containing layer.

The article of this disclosure comprises a release agent comprising a functionalized perfluoropolyether bonded to the outer surface of the metal-containing layer. If there are more than one metal-containing layers supported on the patterned surface, the release agent can be bonded to the outermost metal-containing layer of the article. The functionalized perfluoropolyether includes at least one functional group. The functional group can be attached at the end of the perfluoropolyether. The fluorocarbon moiety can be perfluorinated—that is it can be a perfluoropolyether in which all of the hydrogen atoms are replaced with fluorine atoms. The perfluoropolyethers of this disclosure can comprise an amide group. The functional group can be any group that can chemically bond with the metal-containing layer on the molds of this invention. Examples of useful functional groups include benzotriazoles and phosphonic acids or esters (phosphonates). The functional groups can be directly bonded to the fluorocarbons or can be bonded through a linkage group. Common linkage groups include ether linkages, ester linkages and amide linkages. Functionalized fluorocarbons that are particularly useful in this invention include perfluoropolyether benzotriazole compounds, such as those disclosed in U.S. Pat. No. 7,148,360 B2 (Flynn et al.) and perfluoropolyether amide-linked phosphonates, phosphates, and derivatives thereof as disclosed in U.S. Pat. Publ. No. 2005/0048288 (Flynn et al.), filed Jul. 7, 2004.

In one embodiment the release agent comprises a perfluoropolyether compound according to Formula I, Formula II, or combinations thereof:

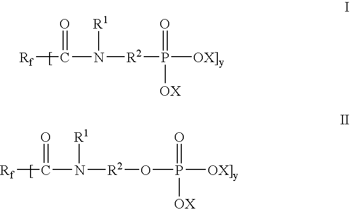

wherein

R_{f} is a monovalent or divalent perfluoropolyether group;

each X is independently hydrogen, alkyl, cycloalkyl, alkali metal, ammonium, ammonium substituted with an alkyl or cycloalkyl, or a five to seven membered heterocyclic group having a positively charged nitrogen atom;

y is equal to 1 or2;

R¹ is hydrogen or alkyl; and

R² comprises a divalent group selected from an alkylene, arylene, heteroalkylene, or combinations thereof and an optional divalent group selected from carbonyl, carbonyloxy, carbonylimino, sulfonamido, or combinations thereof, wherein R² is unsubstituted or substituted with an alkyl, aryl, halo, or combinations thereof. The group R¹ in Formula I or Formula II can be hydrogen or an alkyl. In some embodiments, R¹ is a C₁ to C₄ alkyl.

Each X group in Formula I or Formula II independently can be hydrogen, alkyl, cycloalkyl, alkali metal, ammonium, ammonium substituted with an alkyl or cycloalkyl, or a five to seven membered heterocyclic group having a positively charged nitrogen atom. When each X is hydrogen, the compound according to Formula I or Formula II is a phosphonic acid or monophosphate ester. The compound according to Formula I or Formula II is an ester when at least one X is an alkyl group. Exemplary alkyl groups include those having 1 to 4 carbon atoms. The alkyl group can be linear, branched, or cyclic.

The compound according to Formula I or Formula II is a salt when at least one X is an alkali metal, ammonium, ammonium substituted with an alkyl or cycloalkyl, or a five to seven membered heterocyclic group having a positively charged nitrogen atom. Exemplary alkali metals include sodium, potassium, and lithium. Exemplary substituted ammonium ions include, but are not limited to, tetraalkylammonium ions. The alkyl substituents on the ammonium ion can be linear, branched, or cyclic. Exemplary five or six membered heterocyclic groups having a positively charged nitrogen atom include, but are not limited to, a pyrrolium ion, pyrazolium ion, pyrrolidinium ion, imidazolium ion, triazolium ion, isoxazolium ion, oxazolium ion, thiazolium ion, isothiazolium ion, oxadiazolium ion, oxatriazolium ion, dioxazolium ion, oxathiazolium ion, pyridinium ion, pyridazinium ion, pyrimidinium ion, pyrazinium ion, piperazinium ion, triazinium ion, oxazinium ion, piperidinium ion, oxathiazinium ion, oxadiazinium ion, and morpholinium ion.

The R² group includes a divalent group selected from an alkylene, arylene, heteroalkylene, or combinations thereof and an optional divalent group selected from carbonyl, carbonyloxy, carbonylimino, sulfonamido, or combinations thereof. R² can be unsubstituted or substituted with an alkyl, aryl, halo, or combinations thereof. The R² group typically has no more than 30 carbon atoms. In some compounds, the R² group has no more than 20 carbon atoms, no more than 10 carbon atoms, no more than 6 carbon atoms, or no more than 4 carbon atoms. For example, R² can be an alkylene, an alkylene substituted with an aryl group, or an alkylene in combination with an arylene. In some exemplary compounds, the R² group is a phenylene group connected to an alkylene group where the alkylene group has 1 to 6 carbon atoms. In other exemplary compounds, the R² group is an alkylene group having 1 to 6 carbon atoms that is unsubstituted or substituted with a phenyl or alkyl group.

The perfluoropolyether group R_{f} can be linear, branched, cyclic, or combinations thereof and can be saturated or unsaturated. The perfluoropolyether has at least two catenated oxygen heteroatoms. Exemplary perfluoropolyethers include, but are not limited to, those that have perfluorinated repeating units selected from the group of —(CₚF₂ₚ)—, —(CₚF₂ₚO)—, —(CF(Z))-, —(CF(Z)O)—, —(CF(Z)CₚF₂ₚO)—, —(CₚF₂ₚCF(Z)O)—, —(CF₂CF(Z)O)—, or combinations thereof. In these repeating units, p is typically an integer of 1 to 10. In some embodiments, p is an integer of 1 to 8, 1 to 6, 1 to 4, or 1 to 3. The Z group can be a perfluoroalkyl group, perfluoroether group, perfluoropolyether, or a perfluoroalkoxy group that has a linear structure, branched structure, cyclic structure, or combinations thereof. The Z group typically has no more than 12 carbon atoms, no more than 10 carbon atoms, no more than 8 carbon atoms, no more than 6 carbon toms, no more than 4 carbon atoms, no more than 3 carbon atoms, no more than 2 carbon atoms, or no more than 1 carbon atom. In some embodiments, the Z group can have no more than 4, no more than 3, no more than 2, no more than 1, or no oxygen atoms. In these perfluoropolyether structures, different repeating units can be combined in a block or random arrangement to form the R_{f} group.

R_{f} can be monovalent (i.e., y is 1 in Formulas I or II) or divalent (i.e., y is 2 in Formulas I or II). Where the perfluoropolyether group R_{f} is monovalent, the terminal group of the perfluoropolyether group R_{f} can be (CₚF₂ₚ₊₁)—, (CₚF₂ₚ₊₁O)—, for example, where p is an integer of 1 to 10, 1 to 8, 1 to 6, 1 to 4, or 1 to 3. Some exemplary monovalent perfluoropolyether groups R_{f} include, but are not limited to, C₃F₇O(CF(CF₃)CF₂O)ₙCF(CF₃)—, C₃F₇O(CF₂CF₂CF₂O)ₙCF₂CF₂—, and CF₃O(C₂F₄O)ₙCF₂— wherein n has an average value of 0 to 50, 1 to 50, 3 to 30, 3 to 15, or 3 to 10.

Other exemplary monovalent perfluoropolyether groups R_{f} include, but are not limited to CF₃O(CF₂O)_{q}(C₂F₄O)ₙCF₂— and F(CF₂)₃O(C₄F₈O)ₙ(CF₂)₃—, where q can have an average value of 0 to 50, 1 to 50, 3 to 30, 3 to 15, or to 10; and n can have an average value of 0 to 50, 3 to 30, 3 to 15, or 3 to 10.

Some exemplary divalent perfluoropolyether groups R_{f} include, but are not limited to —CF₂O(CF₂O)_{q}(C₂F₄O)ₙCF₂—, —CF₂O(C₂F₄O)ₙCF₂—, —(CF₂)₃O(C₄F₈O)ₙ(CF₂)₃—, and —CF(CF₃)(OCF₂CF(CF₃))ₛOCₜF₂ₜO(CF(CF₃)CF₂O)ₙCF(CF₃)—

where q can have an average value of 0 to 50, 1 to 50, 3 to 30, 3 to 15, or 3 to 10; n can have an average value of 0 to 50, 3 to 30, 3 to 15, or 3 to 10; s can have an average value of 0 to 50, 1 to 50, 3 to 30, 3 to 15, or 3 to 10; the sum of n and s (i.e., n+s) can have an average value of 0 to 50 or 4 to 40; the sum of q and n (i.e., q+n) can be greater than 0; and t can be an integer of 2 to 6.

As synthesized, the perfluoropolyethers according to Formula I or Formula II typically are mixtures having different perfluoropolyether groups R_{f} (i.e., the compound is not synthesized as a single compound but a mixture of compounds with different R_{f} groups). For example, the values of q, n, and s can vary as long as the mixture has a number average molecular weight of at least 400 g/mole. Suitable mixtures of perfluoropolyether phosphonates and derivatives thereof typically have a number average molecular weight of at least about 400, at least 800, or at least about 1000 g/mole. Mixtures of different perfluoropolyether phosphonates and derivatives thereof often have a molecular weight (number average) of 400 to 10000 g/mole, 800 to 4000 g/mole, or 1000 to 3000 g/mole. Functionalized perfluoropolyethers of Formula II are disclosed in Tonelli et al., J. Fluorine Chem., 95, 51 (1999) along with methods for their preparation. This disclosure is incorporated herein by reference.

In some applications, the solvent can be a hydrofluoroether. Suitable hydrofluoroethers can be represented by the following general Formula III:

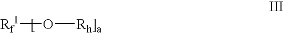

where a is an integer of 1 to 3, R_{f}¹ can be a monovalent, divalent, or trivalent radical of a perfluoroalkane, perfluoroether, or perfluoropolyether that is linear, branched, cyclic, or combinations thereof, and Rₕ can be an alkyl or heteroalkyl group that is linear, branched, cyclic, or combinations thereof. For example, the hydrofluoroether can be methyl perfluorobutyl ether or ethyl perfluorobutyl ether.

Compositions that include a release layer comprising a functionalized perfluoropolyether can be applied in any one of several conventional ways, such as spin coating, spraying, dipping, or vapor deposition. The compounds of Formula I, II, or combinations thereof are often soluble (or dispersible) in hydrofluoroethers such as 3M NOVEC Engineered Fluid HFE-7100 (C₄F₉OCH₃) which is a mixture of two inseparable isomers with essentially identical properties; or other organic solvents such as isopropanol. This solubility allows uniform films of excess material to be applied by dip, spray, or spin coating from a solution. The substrate can then be heated to accelerate monolayer formation, and the excess can be rinsed or wiped away leaving a monolayer film.

The solvent(s) used to apply the coating composition typically include those that are substantially inert (i.e., substantially nonreactive with the compounds of Formula I, II, or combinations thereof), and capable of dispersing or dissolving these materials. In some embodiments, the solvents substantially completely dissolve the compounds according to Formula II, III, or combinations thereof. Examples of appropriate solvents include, but are not limited to, fluorinated hydrocarbons, particularly fluorine-substituted alkanes, ethers, particularly alkyl perfluoroalkyl ethers, and hydrochlorofluoroalkanes and ethers. Mixtures of such solvents can be used.

In some embodiments, the release layer comprises self-assembled monolayers (SAMs) on the surface of the mold or the metal-containing layer in contact with the hierarchical pattern on the mold. SAMs are physicochemically stable and can modify the surface properties of the mold without affecting the shape of the nanofeatures or microstructures of the hierarchical pattern. A SAM film is generally on the order of 1-2 nm in thickness (much smaller than the features of the hierarchical pattern) and can be chemically bonded to the surface of the mold or the outer surface of the metal-containing layer supported on the patterned surface of the mold.

In another aspect this disclosure provides for a method of replication comprising providing a mold comprising a patterned surface and a metal-containing layer having an outer surface, wherein the metal-containing layer is supported on the patterned surface, and the additional step of applying a release agent comprising a functionalized fluorocarbon to the outer surface of the metal-containing layer. The mold comprising a patterned surface can be provided as disclosed earlier in this application. The release agent can be applied in any one of several conventional ways, such as, for example, by spin coating, spraying, dip coating, or vapor deposition. The release agent can comprise a functionalized perfluoropolyether such as those disclosed earlier in this application. The functionalized perfluoropolyether can be derived from hexafluoropropeneoxide (HFPO).

The mold comprises a metal-containing layer, having an outer surface, supported on the patterned surface. The metal-containing layer can comprise a metal or a metal oxide. The metals can be selected from nickel, copper, chromium, aluminum, silver and titanium. When the metal-containing layer comprises nickel the release agent can include a functionalized perfluoropolyether such as those disclosed in Formulas I and II.

Another aspect of this disclosure is a method of replication comprising providing a mold comprising a patterned surface and a metal-containing layer having an outer surface, wherein the metal-containing layer is supported on the patterned surface, applying a release agent comprising a functionalized perfluoropolyether to the outer surface of the metal-containing layer, adding a first replication polymer to the mold in contact with the release agent, and separating the first replication polymer from the mold. The mold can comprise a hierarchical pattern as disclosed earlier in this disclosure. The release agent can be a functionalized perfluoropolyether as described earlier in this disclosure. The release agent can comprise a perfluoropolyether benzotriazole compound or a perfluoropolyether phosphonate, phosphate, or derivates thereof. The release agent is chosen so that the functional group can form a chemical bond with the pattern. The chemical bond can be a strong bond such as a covalent bond, ionic bond, dative bond (coordinate covalent bond), polar covalent bond, or banana bond.

The method of this aspect of the invention includes adding a first replication polymer to the mold in contact with the release agent, and separating the first replication polymer from the mold. The first replication polymer can be any polymer that is useful for forming a replica of the mold. Polymers useful for forming the replica can include thermoplastic polymers and thermosetting polymers known to those skilled in the art. Thermoplastic polymers can include materials that soften or melt above room temperature but that are rigid and can hold structure when at or below room temperature. Some thermoplastic polymers that can be useful to produce replicas include, for example, polymethylmethacrylate (PMMA), polycarbonate (PC), polystyrene (PS), polyvinylchloride (PVC), polypropylene (PP), polyethylene terephtalate (PET), polyetheretherketone (PEEK), polyamide (PA), polysulfone (PSU, very brittle polymer), polyvinylidenefluoride (PVDF), and polyoxymethylene (POM, very soft and elastic polymer).

Thermosetting polymers can also be useful for forming replicas. Thermosetting polymers that are useful include polysiloxanes (such as polydimethyldisiloxane (PDMS)), polyimides (made from curing of polyamic acid), and urethane acrylates. For the replication of nanofeatures and microstructures, the polymers used to form the replica can have low viscosity. This can allow the polymer to flow into and around the small features of the article. It can be useful to apply the polymer to the article under vacuum so that air entrapment between the article and the polymer is minimized. After curing the thermosetting replication polymers or after cooling and solidifying the thermoplastic replication polymers the first replication polymer can be separated from the mold.

The method of replication of this disclosure further comprises solidifying the polymer before separating the polymer from the mold. It is important when replicating structures and features that are in the micron and submicron dimension range to have a very fluid system when applying the replication polymer to the mold. If the replication polymer is a thermoplastic resin, energy, usually in the form of heat, can be used to make the polymer fluid. The resin can then be solidified by cooling to a temperature below its melting or softening point. This temperature can be room temperature or any temperature above or below room temperature depending upon the polymer system chosen. If the replication polymer (or prepolymer) is a thermosetting material then solidification can comprise curing the thermosetting material. Curing can be accomplished in a number of ways including using heat, actinic radiation, a catalyst, moisture or electron beam radiation, to name a few. The solidified replication polymer can be separated from the mold.

The method of this aspect of this disclosure further comprises adding a second replication polymer in contact with the release agent to the mold and then separating the second replication polymer from the mold. The release agent is not reapplied to the mold before the addition of the second replication polymer. The second replication polymer can be made of the same material as the first replication polymer or it can be a different material. The second replication polymer can be a thermosetting or thermoplastic polymer capable of replicating nanofeatures and microstructures as described earlier in this application. The second replication polymer can be solidified before being removed from the mold.

It is possible to make multiple replicas of the mold after one application of release layer and one replication of a first replication polymer. At least two, at least four, at least five, at least ten, at least twenty, at least thirty, at least fifty, or even at least one hundred, or more different replication polymers can contact the mold in succession, and be separated from the mold without reapplication of the release agent. The method of replication of this disclosure can include adding at least eight additional replication polymers to the mold such that each additional replication polymer comes in contact with the release agent, wherein each additional replication polymer is separated from the mold before the next additional replication polymer is added to the mold, and wherein the release layer is applied to the mold only before the first replication polymer is added to the mold.

Objects and advantages of this invention are further illustrated by the following examples, but the particular materials and amounts thereof recited in these examples, as well as other conditions and details, should not be construed to unduly limit this invention. Unless otherwise stated or apparent, all materials used in the following examples are commercially available.

### EXAMPLES

Molds comprising a hierarchical pattern were made according to Applicants' cofiled and copending applications, both entitled “Method of Making Hierarchical Articles” (both Zhang et al.) (Attorney Docket Nos. 62972US002 and 62973US002), and both filed on Jun. 21, 2007.

Lambent PHOS-A100 was obtained from Lambent Technologies, Gurnee, Ill. C₁₆H₃₃PO₃H₂was obtained from Oryza Laboratories, Chemlsford, Mass. EGC-1720 was obtained from 3M Company, St. Paul, Minn. C₈H₁₇PO₃H₂ was obtained from Alfa Aesar, Ward Hill, Mass. C₄F₉(CH₂)₁₁PO₃H was prepared as described in Example 2 of U.S. Pat. No. 6,824,882 (Boardman et al.).

Release Agent A was made according to Example 2 of U.S. Pat. App. No. 2005/0048288 (Flynn et al.).

Release Agent B was synthesized according to Preparatory Example 4 below.

### Preparatory Example 1

### Fabrication of SiO₂ Mold

A 4 μm layer of borophosphosilicate glass (BPSG) was deposited on a 0.5 mm Si (100) (Si wafer was obtained from Montco Silicon Technologies, INC. 500 South Main Street, Spring City, Pa. 19475) by plasma enhanced chemical vapor deposition (PECVD, Model PLASMALAB System100 available form Oxford Instruments, Yatton, UK) using the following parameters listed in Table I below.

TABLE I
Conditions for BPSG Deposition

| Reactant/conditon | Value: | |
|---|---|---|
| SiH₄ | 10-50 | sccm |
| B₂H₆ | 0.1-10 | sccm |
| PH₃ | 0.1-10 | sccm |
| N₂O | 500-2000 | sccm |
| N₂ | 100-1000 | sccm |
| RF power | 50-200 | W |
| Pressure | 1000-2000 | mTorr |
| Temperature | 350-400° | C. |

A 150 nm aluminum film was then evaporatively deposited on the BPSG surface. A 60 nm anti-reflective coating (ARC UV-112 Brewer Science) was deposited on the Al, and then a negative photoresist (PR, Shipley UVN 30) was coated over the ARC, and the photoresist was exposed using interference lithography. After development of the photoresist, a square lattice pattern with holes was formed. The hole size was 0.8 μm with a pitch of 1.6 μm.

Next the ARC layer was removed by reactive ion etching (RIE) for 4 sec and then the Al was patterned by wet etching. Finally, the SiO₂ was then etched by RIE through the Al pattern. The reactive ion etching was done with a Model PLASMALAB System100 available form Oxford Instruments, Yatton, UK and was conducted according to the following conditions described in Table II.

TABLE II
Materials/Conditions used for Reactive Ion Etching

| Reactant/Condition: | Value: | |
|---|---|---|
| C4F8 | 10-50 | sccm |
| O2 | 0.5-5 | sccm |
| RF power | 50-100 | W |
| Inductive Coupling Plasma (ICP) | 1000-2000 | W |
| power | | |
| Pressure | 3-60 | mTorr |

### Preparatory Example 2

### Negative Copy (Replica) of SiO₂ Mold

The fabricated SiO₂ mold from Preparatory Example 1 was pretreated with a release layer before replication. Polyimide precursor (PI 5878G, HD MicroSystems, Cheesequake Rd, Parlin, N.J.) was coated on the treated mold by spin-on coating and then cured by baking first at 12° C. for 30 min and then at 180° C. for 30 min.

### Preparatory Example 3

### Nickel Mold of Replica

The PI replicas from Preparatory Example 2 were adhered to a 500 cm diameter stainless steel disk using double-stick SCOTCH tape, available from 3M, St. Paul, Minn. The mold was made conductive by deposition of a 75 nm layer of silver using electron beam deposition. Nickel electroforming was then performed to replicate the structures. A sulfamate nickel bath was used at a temperature of 54.5° C. and a current density of 18 amps/ft². The thickness of the nickel deposit was about 500 μm thick. After the electroforming was completed the nickel deposit was separated from the mold and was used for further replication in the Examples that follow.

### Preparatory Example 4

### Preparation of HFPO Phosphonic Acid (Release Agent B)

Unless otherwise noted, as used in the examples, “HFPO—” refers to the end group F(CF(CF₃)CF₂O)ₐCF(CF₃)— of the methyl ester F(CF(CF₃)CF₂O)ₐCF(CF₃)C(O)OCH₃, wherein a averages from 4-20, which can be prepared according to the method reported in U.S. Pat. No. 3,250,808 (Moore et al.). N-(2-Bromoethyl)phthalimide, triethyl phosphate, hydrazine and Si(Me)₃Br were obtained from Sigma-Aldrich, Milwaukee, Wis.

### Synthesis of [2-(1,3-Dioxo-1,3-dihydro-isoindol-2-yl)ethyl]phosphonic Acid Diethyl Ester (a)

N-(2-Bromoethyl)phthalimide (20.0 g, 79.05 mmol) was added to triethyl phosphite (65.6 g, 395.25 mmol) slowly at room temperature. The reaction mixture was refluxed for 12 h. The volatile compounds were distilled out under reduced pressure (3 mm Hg) at 60° C. The crude product was dissolved in 50% aqueous ethanol and the precipitate, unreacted N-(2-bromoethyl)phthalimide, was filtered. The removal of solvents from the filtrate gave pure phosphonate (15.5 g, 63%). The spectral data matched with the literature data.

### Synthesis of 2-Aminoethyl)phosphonic Acid Diethyl Ester (b)

Anhydrous hydrazine (10.24 g, 320 mmol) was added dropwise to a solution of phthalimide (a) (9.98 g, 32 mmol) in ethanol (500 mL) at room temperature. The reaction mixture was stirred at room temperature for 12 h. The precipitated phthalyl hydrazide solid was filtered, and the solvent was removed under reduced pressure. The crude product was chromatographed on a silica gel column under nitrogen using a gradient of CHCl₃/MeOH (9:1). Evaporation of the solvent produced 2-aminoethyl)phosphonic Acid Diethyl Ester (b) (4.3 g, 75%). The spectral data matched with the literature data.

### Synthesis of HFPO—C(O)—NH—CH₂CH₂—P(O)(OCH₂CH₃)₂ (c)

HFPO—C(O)—OCH₃ (2.676 g, 2.2 mmol) and 2-Aminoethyl)phosphonic acid diethyl ester (b) (0.3 g, 2.2 mmol) were mixed in a 50 mL round bottom flask and heated to 60° C. under N₂ atmosphere for 3 hrs. The reaction was monitored by IR spectroscopy. After the reaction was complete, 50 mL MTBE was added to the reaction mixture and was washed with 2N HCl (till pH=7) followed by brine (50 mL). The combined organic extracts were dried under MgSO₄. Solvents were evaporated under vacuum to give HFPO—C(O)—NH—CH₂CH₂—P(O)(OCH₂CH₃)₂ (c) as a clear liquid, quantitative.

### Synthesis of HFPO—C(O)—NH—CH₂CH₂—P(O)(OH)₂ (d) (Release Agent B)

Phosphonate ester (c) (0.65 g, 4.77 mmol) was dissolved in 10 mL diethyl ether. To this solution under N₂ atmosphere, trimethyl silylbromide (0.2192 g, 14.31 mmol) was added at once. The reaction mixture was stirred at room temperature for 24 h. 0.15 g of trimethyl silylbromide was added again and stirred for another 12 h. Methanol, 25 mL was added to the reaction mixture and evaporated under vacuum. This procedure was repeated 3 times. The residue was precipitated in water and dried under vacuum. By NMR 80% of ester was deprotected by this method.

### Comparative Examples 1-5 and Examples 1-2

Nickel molds from Preparatory Example 3 were cleaned in a Harrick PDC-3×G plasma cleaner/sterilizer operating at high power for 5 minutes. The molds were then dipped into 0.1% solutions of various release agents as shown in Table III. The molds were then heated in an oven using conditions shown in Table III, allowed to cool to room temperature, rinsed in pure solvent as shown in Table III, and then blown dry under nitrogen.

Polyimide (PI 5878G available from HD MicroSystems, Parlin, N.J.) was coated on the treated nickel mold by spin coating at 2000 revolutions per minute. and then baked at 120° C. for 30 minutes followed by baking at 180° C. for another 15 minutes. After cooling of the polyimide the replica was peeled off of the nickel mold.

Table III summarizes the different release agent for the treatment of the nickel molds. It was found that the separation of the polyimide replica from the nickel mold was strongly affected by the release agent. For example, Lambent PHOS-A100 in ethanol was not effective as a release agent. However when the nickel mold was treated with the other release agents listed in Table III, the polyimide replicas were easily separated from the mold. The number of polyimide replicas made from the nickel mold without reapplication of the release layer is recorded in Table III. The molds treated with perfluoropolyether-based release agents afforded significantly more repetitive releases than the others.

TABLE III
Release Agents for Polyimide Replicas of Nickel Molds

| | | | Oven | | Replicas from |
|---|---|---|---|---|---|
| Example | Release Agent | Solvent (wt %) | Treatment | Rinse Solvent | Treated Mold |
| Comparative | Lambent PHOS-A100 | Ethanol (0.1%) | 150° C./10 min | Ethanol | 0 |
| Example 1 | | | | | |
| Comparative | C₁₆H₃₃PO₃H₂ | Ethanol (0.1%) | 150° C./10 min | Ethanol | 1 |
| Example 2 | | | | | |
| Comparative | EGC-1720 | HFE 7100 (0.1%) | 150° C./10 min | HFE7100; then | 2 |
| Example 3 | | | | Ethanol | |
| Comparative | C₈H₁₇PO₃H₂ | Ethanol (0.1%) | 150° C./10 min | Ethanol | 3 |
| Example 4 | | | | | |
| Comparative | C₄F₉(CH₂)₁₁PO₃H | Ethanol (0.1%) | 150° C./10 min | Ethanol | 3 |
| Example 5 | | | | | |
| Example 1 | Release Agent A | 49:1 | 120° C./5 min * | Ethanol | >10 |
| | | HFE7100: IPA | 150° C./5 min | | |
| | | (0.1%) | 150° C./10 min | | |
| | | | 150° C./15 min | | |
| Example 2 | Release Agent B | Ethanol | 120° C./5 min* | Ethanol | >10 |
| | | | 150° C./5 min | | |
| | | | 150° C./15 min | | |

*Samples heated at different temperatures for different times yielded similar results.

What is claimed is:

1. An article comprising:
a mold comprising a patterned surface;
a metal-containing layer having an outer surface, wherein the metal-containing layer is supported on the patterned surface; and
a release agent comprising a functionalized perfluoropolyether bonded to the outer surface of the metal-containing layer.

2. The article of claim 1 wherein the patterned surface comprises a hierarchical pattern.

3. The article of claim 1 wherein the metal-containing layer comprises a metal selected from nickel, copper, chromium, aluminum, silver and titanium.

4. The article of claim 3 wherein the metal comprises nickel.

5. The article of claim 1 wherein the release agent further comprises a self-assembled monolayer (SAM).

6. The article of claim 5 wherein the release agent is derived from hexafluoropropeneoxide (HFPO).

7. The article of claim 6 wherein the release agent comprises a phosphate, a phosphonate, a benzotriazole, or derivatives thereof.

8. The article of claim 1 wherein the release agent further comprises a material according to Formula I or Formula II. 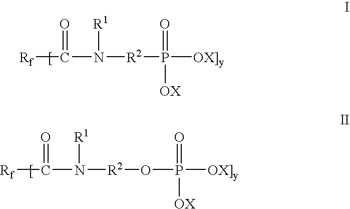
wherein
R_{f} is a monovalent or divalent perfluoropolyether group;
each X is independently hydrogen, alkyl, cycloalkyl, alkali metal, ammonium, ammonium substituted with an alkyl or cycloalkyl, or a five to seven membered heterocyclic group having a positively charged nitrogen atom;
y is equal to 1 or 2;
R¹ is hydrogen or alkyl; and
R² comprises a divalent group selected from an alkylene, arylene, heteroalkylene, or combinations thereof and an optional divalent group selected from carbonyl, carbonyloxy, carbonylimino, sulfonamido, or combinations thereof, wherein R² is unsubstituted or substituted with an alkyl, aryl, halo, or combinations thereof.

9. A method of replication comprising:
providing a mold comprising a patterned surface and a metal-containing layer having an outer surface, wherein the metal-containing layer is supported on the patterned surface; and
applying a release agent comprising a functionalized perfluoropolyether to the outer surface of the metal-containing layer.

10. The method of claim 9 wherein the patterned surface comprises a hierarchical pattern.

11. The method of claim 9 wherein the metal-containing layer comprises a metal selected from nickel, copper, chromium, aluminum, silver and titanium.

12. The method of claim 11 wherein the metal comprises nickel.

13. The method of claim 9 wherein the release agent further comprises a phosphate, a phosphonate, a benzotriazole, or derivatives thereof.

14. The article of method 9 wherein the release agent further comprises a compound according to Formula I, Formula II, or combinations thereof: 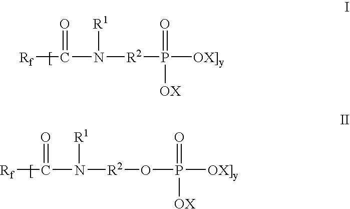
wherein
R_{f} is a monovalent or divalent perfluoropolyether group;
each X is independently hydrogen, alkyl, cycloalkyl, alkali metal, ammonium, ammonium substituted with an alkyl or cycloalkyl, or a five to seven membered heterocyclic group having a positively charged nitrogen atom;
y is equal to 1 or 2;
R¹ is hydrogen or alkyl; and
R² comprises a divalent group selected from an alkylene, arylene, heteroalkylene, or combinations thereof and an optional divalent group selected from carbonyl, carbonyloxy, carbonylimino, sulfonamido, or combinations thereof, wherein R² is unsubstituted or substituted with an alkyl, aryl, halo, or combinations

15. A method of replication comprising:
providing a mold comprising a patterned surface and a metal-containing layer having an outer surface, wherein the metal-containing layer is supported on the patterned surface;
applying a release agent comprising a functionalized perfluoropolyether to the outer surface of the metal-containing layer;
adding a first replication polymer to the mold such that the first replication polymer is in contact with the release agent; and
separating the first replication polymer from the mold.

16. The method of claim 15 wherein the patterned surface comprises a hierarchical pattern.

17. The method of claim 15 wherein the release agent further comprises a phosphate, a phosphonate, a benzotriazole, or derivatives thereof.

18. The method of claim 15 further comprising solidifying the polymer before separating the polymer from the mold.

19. The method of claim 18 wherein solidifying the polymer comprises curing the polymer.

20. The method of claim 15 further comprising:
adding a second replication polymer to the mold such that the first replication polymer is in contact with the release agent; and
separating the second replication polymer from the mold.

21. The method of claim 20, further comprising:
adding at least eight additional replication polymers to the mold such that each additional replication polymer comes in contact with the release agent,
wherein each additional replication polymer is separated from the mold before the next additional replication polymer is added to the mold, and
wherein the release layer is applied to the mold only before the first replication polymer is added to the mold.
